(19) United States
(12) Patent Application Publication
(10) Pub. No.: US 2026/0323294 A1
(43) Pub. Date: Oct. 15, 2026

(54) AUTHORIZATION SCOPE GRANT IN A COMMUNICATIONS NETWORK

(71) Applicant: Telefonaktiebolaget LM Ericsson (publ), Stockholm (SE)

(72) Inventors: Maria Cruz BARTOLOME RODRIGO, Madrid (ES); Jesus Angel DE GREGORIO RODRIGUEZ, Madrid (ES); Miguel MARTINEZ DE LA TORRE, Madrid (ES); Emiliano MERINO VAZQUEZ, Madrid (ES)

(73) Assignee: Telefonaktiebolaget LM Ericsson (publ), Stockholm (SE)

(21) Appl. No.: 19/101,237

(22) PCT Filed: Aug. 3, 2023
(86) PCT No.: PCT/EP2023/071581

§ 371 Date: Feb. 4, 2025

(30) Foreign Application Priority Data
Aug. 5, 2022 (EP) 22382762.7

(51) Int. Cl. H04W 12/084; H04W 12/06; H04W 48/16

(52) U.S. Cl. CPC H04W 12/084; H04W 12/06; H04W 48/16

(57) ABSTRACT

A method comprises receiving at a first network node from a second network node a first indication of a first authorization scope pertaining to the network node type; receiving at the first network node from the second network node a second indication of a second authorization scope pertaining to at least one second network node instance; receiving at the first network node from the second network node a third indication of a precedence pertaining to the first authorization scope and/or the second authorization scope; and granting at the first network node the authorization of the access to the second network node and/or to the authorization scope of the second network node based on the first indication, the second indication, and the third indication.

### TECHNICAL FIELD

The present invention generally relates to authorization mechanisms in communications networks or mobile networks, and more specifically, the invention relates to the grant or allowance of authorization scopes of network nodes in fifth generation (5G) mobile networks.

### BACKGROUND

OAuth 2.0, which stands for “Open Authorization”, is a standard designed to allow a website or application to access resources hosted by other web apps on behalf of a user. In 3GPP 5GC, OAuth 2.0 is used to authorize NF service consumers (e.g. UDM) to access certain resources located in NF service producers (e.g. UDR).

Scope is a mechanism in OAuth 2.0 to limit an application's access to a user's account. In 5GC networks, authorization is achieved by means of NRF (authorization server) providing access tokens which grant permissions to requested scopes. Hence, an NF service consumer (e.g. UDM) can request one or more scopes to access (and update) resources located in requested NF types (e.g. UDR). NRF accepts the requested scopes only if the NF service producer (e.g. UDR) has registered the allowed scopes in NRF for the requesting NF type (e.g. UDM) or the requesting NF instance (unique ID for e.g. a UDM instance).

Problematic aspects of the current solutions are described in the following.

In 3GPP TS 29.510, the attributes “allowedOperationsPerNfType” and “allowedOperationsPerNfInstance” in the NFService type are used to indicate whether a given consumer is allowed to invoke a certain operation (e.g. read, update) on a certain resource, indicated by the OAuth 2.0 scope required for such operation/resource.

The consumer may be indicated either by its NF type or by its unique NF Instance ID.

In the current specification, a given scope requested by a consumer is granted/allowed if such scope is included either in the “allowedOperationsPerNfType” or “allowedOperationsPerNfInstance” attributes, for the NF type and NF Instance ID of the NF service consumer. This means that it is not possible to have a given NF Instance ID having narrower access rights than its corresponding NF type.

E.g., in current specification, if NF type UDM is defined (by all UDR NF instances) as having access to scope A (e.g. users' access and mobility data) of the UDR API, while a specific UDM Instance is defined as having access to scope B (e.g. users' authentication data) of the UDR API, then such UDM instance will always have access to scopes A and B, and it is not possible to restrict the specific UDM instance to ONLY have access to scope A (i.e. to disallow an specific UDM instance to access to users' authentication data) and grant access to scopes A & B for all other UDM NF instances.

### SUMMARY

The invention is set out in the appended set of claims.

An object of the invention is to enable the grant or the authorization for a scope of a network node in a communications network.

A first aspect of the invention relates to a method performed by a first network node for granting or allowing an authorization scope in a communications network. The method comprises receiving at a first network node from a second network node a first indication of a first authorization scope pertaining to the second network node type; receiving at the first network node from the second network node a second indication of a second authorization scope pertaining to at least one second network node instance, particularly wherein the second network node is of the network node type; receiving at the first network node from the second network node a third indication of a precedence pertaining to the first authorization scope and/or the second authorization scope; and granting at the first network node the authorization of the access to the second network node and/or to the authorization scope of the second network node based on the first indication, the second indication, and the third indication, particularly wherein the authorization is part of a network node discovery procedure or an access token request procedure. In some embodiments, the method further comprises receiving at the first network node from a third network node a discovery request for the network node type of the second network node or an access token request for an authorization scope of the second network node; granting at the first network node the access to the second network node and/or to the authorization scope of the second network node by the third network node based on the first indication, the second indication, and the third indication; and transmitting from the first network node to the third network node the discovery result in a discovery response or the access token in an access token response. In some embodiments, the authorization of the access to the second network node and/or to the authorization scope of the second network node comprises determining that the authorization scope for the access to the second network node is included in the second authorization scope. In some embodiments, the authorization of the access to the second network node and/or to the authorization scope of the second network node comprises determining that the authorization scope of the second network node is included in the authorization scope that takes precedence or has higher precedence based on the third indication. In some embodiments, the precedence pertains to the precedence of the first authorization scope, to the precedence of the second authorization scope, or to the precedence between the first authorization scope and the second authorization scope. In some embodiments, the first indication, the second indication and/or the third indication are included in a network node registration request for network node discovery. In some embodiments, the first network node further transmits to the second network node a registration response message indicating the successful registration of the second network node. In some embodiments, the first indication, the second indication and/or the third indication are included in a network node profile, particularly wherein the network node profile is a Network Function Profile. In some embodiments, the selection of the second network node comprises determining that the first authorization scope has higher precedence than the second authorization scope. In some embodiments, the selection of the second network node comprises determining that the first authorization scope overrides the second authorization scope. In some embodiments, the selection of the second network node comprises determining that the second authorization scope has higher precedence than the first authorization scope. In some embodiments, the selection of the second network node comprises determining that the second authorization scope overrides the first authorization scope. In some embodiments, the third indication indicates that the first authorization scope has higher precedence than or overrides the second authorization scope, particularly wherein the third indication is a Boolean indication. In some embodiments, the third indication indicates that the second authorization scope has higher precedence than or overrides the first authorization scope, particularly wherein the third indication is a Boolean indication. In some embodiments, the network node type is a Network Function Type. In some embodiments, the second network node is a network node instance, particularly a Network Function Instance. In some embodiments, the first authorization scope and/or second authorization scope are an OAuth scope. In some embodiments, the first indication is an allowedOperationsPerNfType attribute in the NFProfile data type or NFService data type. In some embodiments, the second indication is an allowedOperationsPerNfInstance attribute in the NFProfile data type or NFService data type. In some embodiments, the third indication is an allowedOperationsPerNfInstanceOverrides attribute in the NFProfile data type or NFService data type. In some embodiments, the first network node is a Network Repository Function, NRF, the second network node is a Network Function producer, and the third network node is a Network Function consumer.

A second aspect of the invention relates to a method performed by a second network node for granting or allowing an authorization scope in a communications network. The method comprises transmitting from a second network node to a first network node a first indication of a first authorization scope pertaining to a network node type; transmitting from the second network node to the first network node a second indication of a second authorization scope pertaining to at least one second network node instance, particularly wherein the second network node is of the network node type; and transmitting from the second network node to the first network node a third indication of a precedence pertaining to the first authorization scope and/or the second authorization scope. In some embodiments, the precedence pertains to the precedence of the first authorization scope, to the precedence of the second authorization scope, or to the precedence between the first authorization scope and the second authorization scope. In some embodiments, the first indication, the second indication and/or the third indication are included in a network node registration request for network node discovery. In some embodiments, the first network node further transmits to the second network node a registration response message indicating the successful registration of the second network node. In some embodiments, the first indication, the second indication and/or the third indication are included in a network node profile, particularly wherein the network node profile is a Network Function Profile. In some embodiments, the third indication indicates that the first authorization scope has higher precedence than or overrides the second authorization scope, particularly wherein the third indication is a Boolean indication. In some embodiments, the third indication indicates that the second authorization scope has higher precedence than or overrides the first authorization scope, particularly wherein the third indication is a Boolean indication. In some embodiments, the network node type is a Network Function Type. In some embodiments, the second network node is a network node instance, particularly a Network Function Instance. In some embodiments, the first authorization scope and/or second authorization scope are an OAuth scope. In some embodiments, the first indication is an allowedOperationsPerNfType attribute in the NFProfile data type or NFService data type. In some embodiments, the second indication is an allowedOperationsPerNfInstance attribute in the NFProfile data type or NFService data type. In some embodiments, the third indication is an allowedOperationsPerNfInstanceOverrides attribute in the NFProfile data type or NFService data type. In some embodiments, the first network node is a Network Repository Function, NRF, the second network node is a Network Function producer.

A third aspect of the invention relates to a method performed by a third network node for granting or allowing an authorization scope in a communications network. The method comprises transmitting from a third network node to a first network node a discovery request for the network node type of the second network node or an access token request for an authorization scope of the second network node; and receiving at the third network node from the first network node the selection result in a discovery response or the access token in an access token response. In some embodiments, the authorization of the access to the second network node and/or to the authorization scope of the second network node comprises determining that the authorization scope for the access to the second network node is included in the second authorization scope. In some embodiments, the authorization of the access to the second network node and/or to the authorization scope of the second network node comprises determining that the authorization scope of the second network node is included in the authorization scope that takes precedence or has higher precedence based on the third indication. In some embodiments, the precedence pertains to the precedence of the first authorization scope, to the precedence of the second authorization scope, or to the precedence between the first authorization scope and the second authorization scope. In some embodiments, the selection of the second network node comprises determining that the first authorization scope has higher precedence than the second authorization scope. In some embodiments, the selection of the second network node comprises determining that the first authorization scope overrides the second authorization scope. In some embodiments, the selection of the second network node comprises determining that the second authorization scope has higher precedence than the first authorization scope. In some embodiments, the selection of the second network node comprises determining that the second authorization scope overrides the first authorization scope. In some embodiments, the network node type is a Network Function Type. In some embodiments, the second network node is a network node instance, particularly a Network Function Instance. In some embodiments, the first authorization scope and/or second authorization scope are an OAuth scope. In some embodiments, the first network node is a Network Repository Function, NRF, the second network node is a Network Function producer, and the third network node is a Network Function consumer.

Other aspects of the invention relate to mobile network nodes, particularly a first network node (110, 500), a second network node (600), a third network node (700) configured to perform the respective methods as described herein. Other aspects of the invention relate to computer program and computer program products.

In some embodiments, the first network node is a Network Repository Function (NRF). In some embodiments, the second network node is a Network Function producer (NFp). In some embodiments, the third network node is a Network Function consumer (NFc).

Advantageously, the solution disclosed herein enables flexibility to define multiple scopes for a given NF type but restricting some scopes for specific NF instances of the same NF type. Additional objectives, features and advantages of the concepts disclosed herein will be apparent from the following description, claims and drawings, or may be learned by practice of the described technologies and concepts as set forth herein.

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings.

FIG. 1 illustrates an example networked system in accordance with particular embodiments of the solution described herein.

FIG. 2 illustrates an example flowchart showing a method performed by a mobile network node according to particular embodiments of the solution described herein.

FIG. 3 illustrates an example flowchart showing a method performed by a mobile network node according to particular embodiments of the solution described herein.

FIG. 4 illustrates an example flowchart showing a method performed by a mobile network node according to particular embodiments of the solution described herein.

FIG. 5 illustrates an example block diagram of a mobile network node configured in accordance with particular embodiments of the solution described herein.

FIG. 6 illustrates an example block diagram of a mobile network node configured in accordance with particular embodiments of the solution described herein.

FIG. 7 illustrates an example block diagram of a mobile network node configured in accordance with particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

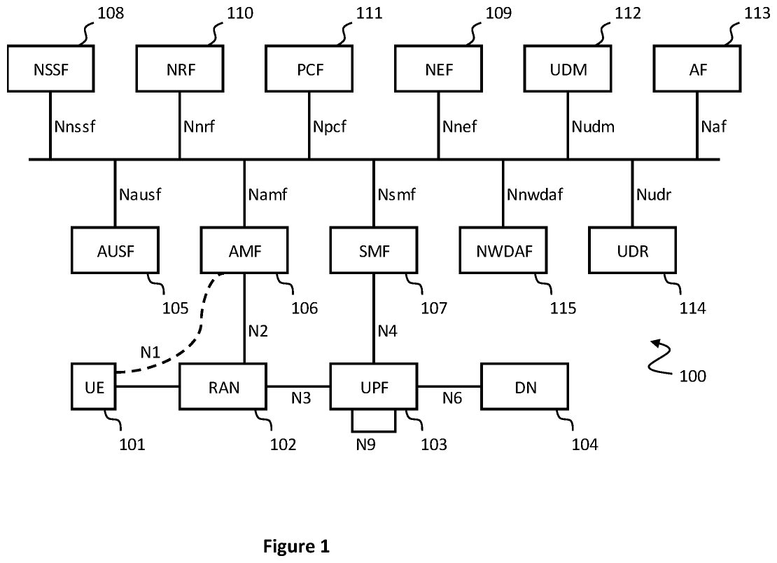

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113.

Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, each one of the entities in the networked system 100 are considered to be a Network Function (NF). One or more additional instances of the NFs may be incorporated into the networked system.

The solution described herein aims to enable the grant or the authorization for a scope of a network node in a communications network.

This disclosure provides a method for granting or allowing an authorization scope in a communications network. The method comprises receiving at a first network node from a second network node a first indication of a first authorization scope pertaining to a network node type; receiving at the first network node from the second network node a second indication of a second authorization scope pertaining to at least one second network node instance, particularly wherein the second network node is of the network node type;

receiving at the first network node from the second network node a third indication of a precedence pertaining to the first authorization scope and/or the second authorization scope; and granting at the first network node the authorization of the access to the second network node and/or to the authorization scope of the second network node based on the first indication, the second indication, and the third indication, particularly wherein the authorization is part of a network node discovery procedure or an access token request procedure. In some embodiments, the method further comprises receiving at the first network node from a third network node a discovery request for the network node type of the second network node or an access token request for an authorization scope of the second network node; granting at the first network node the access to the second network node and/or to the authorization scope of the second network node by the third network node based on the first indication, the second indication, and the third indication; and transmitting from the first network node to the third network node the selection result in a discovery response or the access token in an access token response. In some embodiments, the authorization of the access to the second network node and/or to the authorization scope of the second network node comprises determining that the authorization scope for the access to the second network node is included in the second authorization scope. In some embodiments, the authorization of the access to the second network node and/or to the authorization scope of the second network node comprises determining that the authorization scope of the second network node is included in the authorization scope that takes precedence or has higher precedence based on the third indication. In some embodiments, the precedence pertains to the precedence of the first authorization scope, to the precedence of the second authorization scope, or to the precedence between the first authorization scope and the second authorization scope. In some embodiments, the first indication, the second indication and/or the third indication are included in a network node registration request for network node discovery. In some embodiments, the first network node further transmits to the second network node a registration response message indicating the successful registration of the second network node. In some embodiments, the first indication, the second indication and/or the third indication are included in a network node profile, particularly wherein the network node profile is a Network Function Profile. In some embodiments, the selection of the second network node comprises determining that the first authorization scope has higher precedence than the second authorization scope. In some embodiments, the selection of the second network node comprises determining that the first authorization scope overrides the second authorization scope. In some embodiments, the selection of the second network node comprises determining that the second authorization scope has higher precedence than the first authorization scope. In some embodiments, the selection of the second network node comprises determining that the second authorization scope overrides the first authorization scope. In some embodiments, the third indication indicates that the first authorization scope has higher precedence than or overrides the second authorization scope, particularly wherein the third indication is a Boolean indication. In some embodiments, the third indication indicates that the second authorization scope has higher precedence than or overrides the first authorization scope, particularly wherein the third indication is a Boolean indication. In some embodiments, the network node type is a Network Function Type. In some embodiments, the second network node is a network node instance, particularly a Network Function Instance. In some embodiments, the first authorization scope and/or second authorization scope are an OAuth scope. In some embodiments, the first indication is an allowedOperationsPerNfType attribute in the NFProfile data type or NFService data type. In some embodiments, the second indication is an allowedOperationsPerNfInstance attribute in the NFProfile data type or NFService data type. In some embodiments, the third indication is an allowedOperationsPerNfInstanceOverrides attribute in the NFProfile data type or NFService data type. In some embodiments, the first network node is a Network Repository Function, NRF, the second network node is a Network Function producer, and the third network node is a Network Function consumer.

This disclosure also provides mobile network nodes, particularly a first network node (110, 500), a second network node (600), a third network node (700) configured to perform the respective methods as described herein. In some embodiments, the first network node is a Network Repository Function (NRF) 110. In some embodiments, the second network node is a Network Function producer (NFp). In some embodiments, the third network node is a Network Function consumer (NFc).

This disclosure also provides the corresponding computer program and computer program products comprising code, for example in the form of a computer program, that when run on processing circuitry of the mobile network nodes causes the mobile network nodes to perform the disclosed methods.

The solution and the features comprised therein are further described in what follows.

The NFp, at NF registration in NRF, provides a new flag as part of its NFp profile, indicating that the scopes included in “allowedOperationsPerNfInstance” have precedence over (i.e. override) the scopes included in “allowedOperationsPerNfType” when the NF type of the NF Instance in the former attribute is also included in the latter.

E.g. in example described in previous clause, if allowedOperationsPerNfType includes scopes A & B, and allowedOperationsPerNfInstance includes scope A only, if the new indication is provided, then NRF will grant access only to scope A for the specific NF instance, and scopes A & B for the rest of NF instances of the same type.

This disclosure describes a mechanism to restrict/narrow down access to specific NF instances of a certain NF type, keeping all other instances with the (broader) access as defined for the NF type.

The solution needs to keep the mandatory backward compatibility in 3GPP APIs, and describes two alternatives:
1) A new flag (allowedOperationsPerNfInstanceOverrides) indicating that the NF instance allowed scopes override the NF type allowed scopes, e.g. if NF type allowed scopes are 1, 2, 3, 4, 5, 6 and a specific NF instance cannot be granted with scope 6 (but all other scopes are to be granted), the NF instance scopes should be 1, 2, 3, 4, 5 and the new flag should be included and set to TRUE.
2) A new attribute (restrictedOperationsPerNfInstance) indicating the scopes that are not allowed for the NF instance from those allowed for the corresponding NF type, e.g. if NF type allowed scopes are 1, 2, 3, 4, 5, 6 and a specific NF instance cannot be granted with scope 6 (but all other scopes are to be granted), the new attribute should contain scope 6 only. This means that the same scope cannot be present in both the new attribute restrictedOperationsPerNfInstance and the existing attribute allowedOperationsPerNfInstance simultaneously.

In some embodiments, in addition to authorizing the access operation (typically understood as a read operation), other operations are authorized, for example write, update or delete operations.

These attributes are used in order to determine whether a given resource/operation-level scope shall be granted to an NF Service Consumer that requested an Oauth2 access token with a specific scope. If attribute “allowedOperationsPerNfInstanceOverrides” is absent, or set to false, the NRF shall grant such scope in the access token, if the scope is present in either “allowedOperationsPerNfType”, for the specific NF type of the NF Service Consumer, or in “allowedOperationsPerNfInstance”, for the specific instance ID of the NF Service Consumer; if attribute “allowedOperationsPerNfInstanceOverrides” is present and set to true, the NRF shall grant such scope in the access token, if the scope is present in the Advantageously, the proposed solution enables flexibility to define multiple scopes for a given NF type but restricting some scopes for specific NF instances of the same NF type.

Hereinafter, flowcharts showing examples of embodiments of the solution are described in detail.

The embodiments correspond to methods performed by and involving a first network node (110, 500), a second network node (600), a third network node (700).

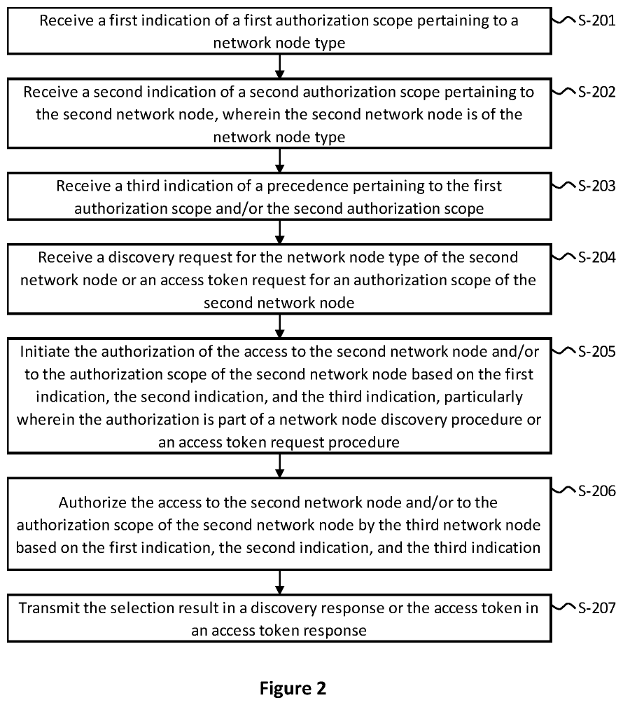

FIG. 2 is a flowchart illustrating a method performed by the first network node for granting or allowing an authorization scope in a communications network.

In step S-201, the first network node receives from a second network node a first indication of a first authorization scope pertaining to a network node type.

In step S-202, the first network node receives from the second network node a second indication of a second authorization scope pertaining to the second network node, wherein the second network node is of the network node type.

In step S-203, the first network node receives from the second network node a third indication of a precedence pertaining to the first authorization scope and/or the second authorization scope.

In step S-204, the first network node receives from a third network node a discovery request for the network node type of the second network node or an access token request for an authorization scope of the second network node.

In step S-205, the first network node initiates the authorization of the access to the second network node and/or to the authorization scope of the second network node based on the first indication, the second indication, and the third indication, particularly wherein the authorization is part of a network node discovery procedure or an access token request procedure.

In step S-206, the first network node authorizes the access to the second network node and/or to the authorization scope of the second network node by the third network node based on the first indication, the second indication, and the third indication.

In step S-207, the first network node transmits to the third network node the selection result in a discovery response or the access token in an access token response.

In some embodiments, the authorization of the access to the second network node and/or to the authorization scope of the second network node comprises determining that the authorization scope for the access to the second network node is included in the second authorization scope.

In some embodiments, the authorization of the access to the second network node and/or to the authorization scope of the second network node comprises determining that the authorization scope of the second network node is included in the authorization scope that takes precedence or has higher precedence based on the third indication.

In some embodiments, the precedence pertains to the precedence of the first authorization scope, to the precedence of the second authorization scope, or to the precedence between the first authorization scope and the second authorization scope.

In some embodiments, the first indication, the second indication and/or the third indication are included in a network node registration request for network node discovery.

In some embodiments, the first network node further transmits to the second network node a registration response message indicating the successful registration of the second network node.

In some embodiments, the first indication, the second indication and/or the third indication are included in a network node profile, particularly wherein the network node profile is a Network Function Profile.

In some embodiments, the selection of the second network node comprises determining that the first authorization scope has higher precedence than the second authorization scope.

In some embodiments, the selection of the second network node comprises determining that the first authorization scope overrides the second authorization scope.

In some embodiments, the selection of the second network node comprises determining that the second authorization scope has higher precedence than the first authorization scope.

In some embodiments, the selection of the second network node comprises determining that the second authorization scope overrides the first authorization scope.

In some embodiments, the third indication indicates that the first authorization scope has higher precedence than or overrides the second authorization scope, particularly wherein the third indication is a Boolean indication.

In some embodiments, the third indication indicates that the second authorization scope has higher precedence than or overrides the first authorization scope, particularly wherein the third indication is a Boolean indication.

In some embodiments, the network node type is a network function type.

In some embodiments, the second network node is a network node instance, particularly a Network Function Instance.

In some embodiments, the first authorization scope and/or second authorization scope are an OAuth scope.

In some embodiments, the first indication is an allowedOperationsPerNfType attribute in the NFProfile data type or NFService data type.

In some embodiments, the second indication is an allowedOperationsPerNfInstance attribute in the NFProfile data type or NFService data type.

In some embodiments, the third indication is an allowedOperationsPerNfInstanceOverrides attribute in the NFProfile data type or NFService data type.

In some embodiments, the first network node is a Network Repository Function, NRF, the second network node is a Network Function producer, and the third network node is a Network Function consumer.

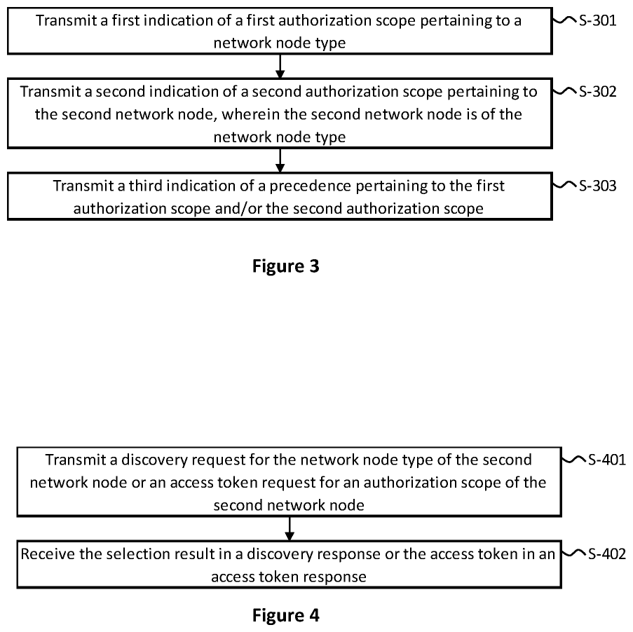

FIG. 3 is a flowchart illustrating a method performed by the second network node for granting or allowing an authorization scope in a communications network.

In step S-301, the second network node transmits to a first network node a first indication of a first authorization scope pertaining to a network node type.

In step S-302, the second network node transmits to the first network node a second indication of a second authorization scope pertaining to the second network node, wherein the second network node is of the network node type.

In step S-303, the second network node transmits to the first network node a third indication of a precedence pertaining to the first authorization scope and/or the second authorization scope.

In some embodiments, the precedence pertains to the precedence of the first authorization scope, to the precedence of the second authorization scope, or to the precedence between the first authorization scope and the second authorization scope.

In some embodiments, the first indication, the second indication and/or the third indication are included in a network node registration request for network node discovery.

In some embodiments, the first network node further transmits to the second network node a registration response message indicating the successful registration of the second network node.

In some embodiments, the first indication, the second indication and/or the third indication are included in a network node profile, particularly wherein the network node profile is a Network Function Profile.

In some embodiments, the third indication indicates that the first authorization scope has higher precedence than or overrides the second authorization scope, particularly wherein the third indication is a Boolean indication.

In some embodiments, the third indication indicates that the second authorization scope has higher precedence than or overrides the first authorization scope, particularly wherein the third indication is a Boolean indication.

### In Some Embodiments, the Network Node Type Is a Network Function Type.

In some embodiments, the second network node is a network node instance, particularly a Network Function Instance.

In some embodiments, the first authorization scope and/or second authorization scope are an OAuth scope.

In some embodiments, the first indication is an allowedOperationsPerNfType attribute in the NFProfile data type or NFService data type.

In some embodiments, the second indication is an allowedOperationsPerNfInstance attribute in the NFProfile data type or NFService data type.

In some embodiments, the third indication is an allowedOperationsPerNfInstanceOverrides attribute in the NFProfile data type or NFService data type.

In some embodiments, the first network node is a Network Repository Function, NRF, the second network node is a Network Function producer.

FIG. 4 is a flowchart illustrating a method performed by the third network node for granting or allowing an authorization scope in a communications network.

In step S-401, the third network node transmits to a first network node a discovery request for the network node type of the second network node or an access token request for an authorization scope of the second network node.

In step S-402, the third network node receives from the first network node the selection result in a discovery response or the access token in an access token response.

In some embodiments, the authorization of the access to the second network node and/or to the authorization scope of the second network node comprises determining that the authorization scope for the access to the second network node is included in the second authorization scope.

In some embodiments, the authorization of the access to the second network node and/or to the authorization scope of the second network node comprises determining that the authorization scope of the second network node is included in the authorization scope that takes precedence or has higher precedence based on the third indication.

In some embodiments, the precedence pertains to the precedence of the first authorization scope, to the precedence of the second authorization scope, or to the precedence between the first authorization scope and the second authorization scope.

In some embodiments, the selection of the second network node comprises determining that the first authorization scope has higher precedence than the second authorization scope.

In some embodiments, the selection of the second network node comprises determining that the first authorization scope overrides the second authorization scope.

In some embodiments, the selection of the second network node comprises determining that the second authorization scope has higher precedence than the first authorization scope.

In some embodiments, the selection of the second network node comprises determining that the second authorization scope overrides the first authorization scope.

In some embodiments, the network node type is a Network Function Type.

In some embodiments, the second network node is a network node instance, particularly a Network Function Instance.

In some embodiments, the first authorization scope and/or second authorization scope are an OAuth scope.

In some embodiments, the first network node is a Network Repository Function, NRF, the second network node is a Network Function producer, and the third network node is a Network Function consumer.

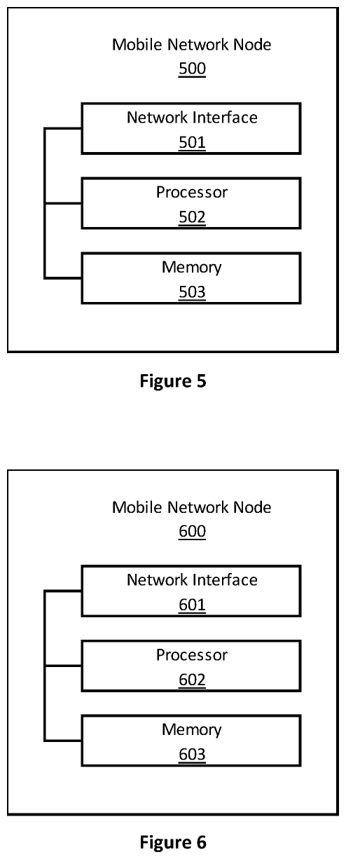

FIG. 5 is a block diagram illustrating elements of a mobile network node 500 of a mobile communications network. In some embodiments, the mobile network node 500 is a NRF 110. As shown, the mobile network node may include network interface circuitry 501 (also referred to as a network interface) configured to provide communications with other nodes of the core network and/or the network. The mobile network node may also include a processing circuitry 502 (also referred to as a processor) coupled to the network interface circuitry, and memory circuitry 503 (also referred to as memory) coupled to the processing circuitry. The memory circuitry 503 may include computer readable program code that when executed by the processing circuitry 502 causes the processing circuitry to perform operations according to embodiments disclosed herein. According to other embodiments, processing circuitry 502 may be defined to include memory so that a separate memory circuitry is not required. As discussed herein, operations of the mobile network node may be performed by processing circuitry 502 and/or network interface circuitry 501. For example, processing circuitry 502 may control network interface circuitry 501 to transmit communications through network interface circuitry 501 to one or more other network nodes and/or to receive communications through network interface circuitry from one or more other network nodes. Moreover, modules may be stored in memory 503, and these modules may provide instructions so that when instructions of a module are executed by processing circuitry 502, processing circuitry 502 performs respective operations (e.g., operations discussed below with respect to Example Embodiments relating to core network nodes).

FIG. 6 is a block diagram illustrating elements of a mobile network node 600 of a mobile communications network. In some embodiments, the mobile network node 600 is NFp. As shown, the mobile network node may include network interface circuitry 601 (also referred to as a network interface) configured to provide communications with other nodes of the core network and/or the network. The mobile network node may also include a processing circuitry 602 (also referred to as a processor) coupled to the network interface circuitry, and memory circuitry 603 (also referred to as memory) coupled to the processing circuitry. The memory circuitry 603 may include computer readable program code that when executed by the processing circuitry 602 causes the processing circuitry to perform operations according to embodiments disclosed herein. According to other embodiments, processing circuitry 602 may be defined to include memory so that a separate memory circuitry is not required. As discussed herein, operations of the mobile network node may be performed by processing circuitry 602 and/or network interface circuitry 601. For example, processing circuitry 602 may control network interface circuitry 601 to transmit communications through network interface circuitry 601 to one or more other network nodes and/or to receive communications through network interface circuitry from one or more other network nodes. Moreover, modules may be stored in memory 603, and these modules may provide instructions so that when instructions of a module are executed by processing circuitry 602, processing circuitry 602 performs respective operations (e.g., operations discussed below with respect to Example Embodiments relating to core network nodes).

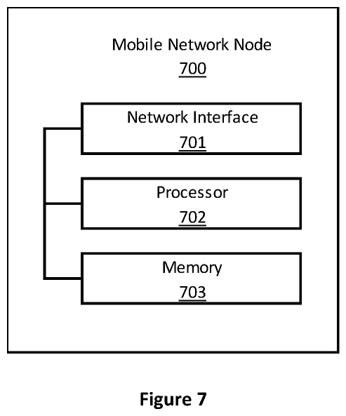

FIG. 7 is a block diagram illustrating elements of a mobile network node 700 of a mobile communications network. In some embodiments, the mobile network node 700 is NFc. As shown, the mobile network node may include network interface circuitry 701 (also referred to as a network interface) configured to provide communications with other nodes of the core network and/or the network. The mobile network node may also include a processing circuitry 702 (also referred to as a processor) coupled to the network interface circuitry, and memory circuitry 703 (also referred to as memory) coupled to the processing circuitry. The memory circuitry 703 may include computer readable program code that when executed by the processing circuitry 702 causes the processing circuitry to perform operations according to embodiments disclosed herein. According to other embodiments, processing circuitry 702 may be defined to include memory so that a separate memory circuitry is not required. As discussed herein, operations of the mobile network node may be performed by processing circuitry 702 and/or network interface circuitry 701. For example, processing circuitry 702 may control network interface circuitry 701 to transmit communications through network interface circuitry 701 to one or more other network nodes and/or to receive communications through network interface circuitry from one or more other network nodes. Moreover, modules may be stored in memory 703, and these modules may provide instructions so that when instructions of a module are executed by processing circuitry 702, processing circuitry 702 performs respective operations (e.g., operations discussed below with respect to Example Embodiments relating to core network nodes).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof. Further, all terms used in the claims are to be interpreted according to their ordinary meaning in the technical field, unless explicitly defined otherwise herein. All references to ““a/an/the element, apparatus, component, means, module, step, etc.”” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

1-21. (canceled)

22. A method performed by a first network node for granting or allowing an authorization scope in a communications network, the method comprising:
receiving at a first network node from a second network node a first indication of a first authorization scope pertaining to the second network node type;
receiving at the first network node from the second network node a second indication of a second authorization scope pertaining to at least one second network node instance;
receiving at the first network node from the second network node a third indication of a precedence pertaining to the first authorization scope and/or the second authorization scope; and
granting at the first network node the authorization of the access to the second network node and/or to the authorization scope of the second network node based on the first indication, the second indication, and the third indication, particularly wherein the authorization is part of a network node discovery procedure or an access token request procedure;
wherein the first network node is a Network Repository Function, NRF.

23. The method of claim 22, further comprising:
receiving at the first network node from a third network node a discovery request for the network node type of the second network node or an access token request for an authorization scope of the second network node;
granting at the first network node the access to the second network node and/or to the authorization scope of the second network node by the third network node based on the first indication, the second indication, and the third indication; and
transmitting from the first network node to the third network node the discovery result in a discovery response or transmitting the access token in an access token response.

24. The method of claim 23, wherein the authorization of the access to the second network node and/or to the authorization scope of the second network node comprises determining that the authorization scope for the access to the second network node is included in the second authorization scope.

25. The method of claim 23, wherein the authorization of the access to the second network node and/or to the authorization scope of the second network node comprises determining that the authorization scope of the second network node is included in the authorization scope that takes precedence or has higher precedence based on the third indication.

26. The method of claim 22, wherein the precedence pertains to the precedence of the first authorization scope, to the precedence of the second authorization scope, or to the precedence between the first authorization scope and the second authorization scope.

27-30. (canceled)

31. The method of claim 22, wherein the selection of the second network node comprises determining that the first authorization scope overrides the second authorization scope, determining that the second authorization scope has higher precedence than the first authorization scope, or determining that the second authorization scope overrides the first authorization scope.

32-41. (canceled)

42. The method of claim 22, wherein the second network node is a Network Function producer, and the third network node is a Network Function consumer.

43. A method performed by a second network node for granting or allowing an authorization scope in a communications network, the method comprising:
transmitting from a second network node to a first network node a first indication of a first authorization scope pertaining to the second network node type;
transmitting from the second network node to the first network node a second indication of a second authorization scope pertaining to at least one second network node instance; and
transmitting from the second network node to the first network node a third indication of a precedence pertaining to the first authorization scope and/or the second authorization scope;
wherein the first network node is a Network Repository Function, NRF.

44. The method of claim 43, wherein the precedence pertains to the precedence of the first authorization scope, to the precedence of the second authorization scope, or to the precedence between the first authorization scope and the second authorization scope.

45. The method of claim 43, wherein the first indication, the second indication and/or the third indication are included in a network node registration request for network node discovery.

46. (canceled)

47. The method of claim 43, wherein the first indication, the second indication and/or the third indication are included in a network node profile, particularly wherein the network node profile is a Network Function Profile.

48. The method of claim 43, wherein the third indication indicates that the first authorization scope has higher precedence than or overrides the second authorization scope, particularly wherein the third indication is a Boolean indication.

49. The method of claim 43, wherein the third indication indicates that the second authorization scope has higher precedence than or overrides the first authorization scope, particularly wherein the third indication is a Boolean indication.

50-55. (canceled)

56. The method of claim 43, wherein the second network node is a Network Function producer.

57. A method performed by a third network node for granting or allowing an authorization scope in a communications network, the method comprising:
transmitting from a third network node to a first network node a discovery request for the network node type of the second network node or an access token request for an authorization scope of the second network node; and
receiving at the third network node from the first network node the discovery result in a discovery response or receiving the access token in an access token response;
wherein the first network node is a Network Repository Function, NRF.

58. The method of claim 57, wherein the authorization of the access to the second network node and/or to the authorization scope of the second network node comprises determining that the authorization scope for the access to the second network node is included in a second authorization scope.

59. The method of claim 57, wherein the authorization of the access to the second network node and/or to the authorization scope of the second network node comprises determining that the authorization scope of the second network node is included in the authorization scope that takes precedence or has higher precedence based on a third indication.

60. The method of claim 57, wherein the precedence pertains to the precedence of a first authorization scope, to the precedence of the second authorization scope, or to the precedence between the first authorization scope and the second authorization scope.

61. The method of claim 57, wherein the selection of the second network node comprises determining that the first authorization scope has higher precedence than the second authorization scope, determining that the first authorization scope overrides the second authorization scope, determining that the second authorization scope has higher precedence than the first authorization scope, or determining that the second authorization scope overrides the first authorization scope.

62-68. (canceled)

69. Apparatus for granting or allowing an authorization scope in a communications network, the apparatus comprising a processor and a memory, the memory containing instructions executable by the processor such that the apparatus is operable to perform the method of claim 22.

70. Apparatus for granting or allowing an authorization scope in a communications network, the apparatus comprising a processor and a memory, the memory containing instructions executable by the processor such that the apparatus is operable to perform the method of claim 43.

71. Apparatus for granting or allowing an authorization scope in a communications network, the apparatus comprising a processor and a memory, the memory containing instructions executable by the processor such that the apparatus is operable to perform the method of claim 57.

72-75. (canceled)
